(19) United States
(12) Patent Application Publication
(10) Pub. No.: US 2026/0288180 A1
(43) Pub. Date: Sep. 24, 2026

(54) ADAPTIVELY BIASED LOW-DROPOUT VOLTAGE REGULATOR

(71) Applicant: Avago Technologies International Sales Pte. Limited, Singapore (SG)

(72) Inventor: Dong Wang, Singapore (SG)

(21) Appl. No.: 19/088,458

(22) Filed: Mar. 24, 2025

(51) Int. Cl. G05F 1/56

(52) U.S. Cl. CPC G05F 1/56

(57) ABSTRACT

An example voltage regulator includes: a first node configured to receive a first direct-current (DC) voltage; a second node configured to supply a second DC voltage; a third node configured to supply an electrical ground; a first transistor coupled between the first node and the second node; a first network coupled between the second node and the third node, the first network outputting a first voltage; and a control circuit including: an error amplifier configured to supply a third voltage to a gate of the first transistor based on comparison of the first voltage with a second voltage; and a first circuit coupled between the second node and the third node, the first circuit configured to provide a current path between the second node and the third node in response to a first current through the first transistor being less than a threshold and disconnect the current path otherwise.

### BACKGROUND

The demand for improved power efficiency of power management units (PMUs) in battery-powered electronic devices has grown extensively to extend battery life. Such PMUs can include a low-dropout (LDO) regulator to provide direct current (DC) voltage regulation of the battery voltage source. The advantages of an LDO regulator over other DC-to-DC voltage regulators can include the absence of switching noise, smaller device size, high power efficiency, and high bandwidth. There are, however, design challenges for an LDO regulator in the presence of unpredictable load conditions, such as a transition from no load to light load, a transition from moderate load to heavy load, an over-load condition, and a short-circuit condition. There is a need in the art for an LDO regulator that can achieve robust performance with sustainable current efficiency across different load conditions.

### SUMMARY

In an embodiment, a voltage regulator can include a first node configured to receive a first direct-current (DC) voltage, a second node configured to supply a second DC voltage, and a third node configured to supply an electrical ground. The voltage regulator can include a first transistor coupled between the first node and the second node, and a first network coupled between the second node and the third node, the first network outputting a first voltage. The voltage regulator can include a control circuit. The control circuit can include an error amplifier configured to supply a third voltage to a gate of the first transistor based on comparison of the first voltage with a second voltage. The control circuit can include a first circuit coupled between the second node and the third node. The first circuit can be configured to provide a current path between the second node and the third node in response to a first current through the first transistor being less than a threshold and disconnect the current path otherwise.

In another embodiment, a voltage regulator can include a first node configured to receive a first direct-current (DC) voltage, a second node configured to supply a second DC voltage, and a third node configured to supply an electrical ground. The voltage regulator can include a first transistor coupled between the first node and the second node, and a first network coupled between the second node and the third node, the first network outputting a first voltage. The voltage regulator can include a control circuit. The control circuit can include a first error amplifier configured to supply a third voltage to a gate of the first transistor based on comparison of the first voltage with a second voltage. The control circuit can include a first circuit configured to generate a second current proportional to a first current through the first transistor and control the third voltage to limit the first current in response to the second current exceeding a threshold.

In another embodiment, a voltage regulator can include a first node configured to receive a first direct-current (DC) voltage, a second node configured to supply a second DC voltage, and a third node configured to supply an electrical ground. The voltage regulator can include a first transistor coupled between the first node and the second node, and a first network coupled between the second node and the third node, the first network outputting a first voltage. The voltage regulator can include a control circuit. The control circuit can include a first error amplifier configured to supply a third voltage to a gate of the first transistor based on comparison of the first voltage with a second voltage. The control circuit can include a first circuit configured to generate a second current proportional to a first current through the first transistor and supply the second current to a second network coupled to the second node and the first error amplifier.

### BRIEF DESCRIPTION OF THE DRAWINGS

FIG. 1 is a block diagram depicting a device according to some embodiments.

FIG. 2 is a schematic diagram depicting an LDO regulator coupled to load according to some embodiments.

FIG. 3 is a schematic diagram depicting a control circuit for an LDO regulator according to some embodiments.

FIG. 4 is a schematic diagram depicting a feedback loop of control a circuit according to some embodiments.

FIG. 5 is a schematic diagram depicting another feedback loop of a control circuit according to some embodiments.

FIG. 6 is a schematic diagram depicting an adaptive bias loop for an LDO regulator according to some embodiments.

FIG. 7 is a schematic diagram depicting a transconductance clamp according to some embodiments.

FIG. 8 is a schematic diagram depicting another feedback loop of a control circuit according to some embodiments.

FIG. 9 is a schematic diagram depicting adaptive damping factor control (ADFC)-based frequency compensation in a control circuit according to some embodiments.

### DETAILED DESCRIPTION

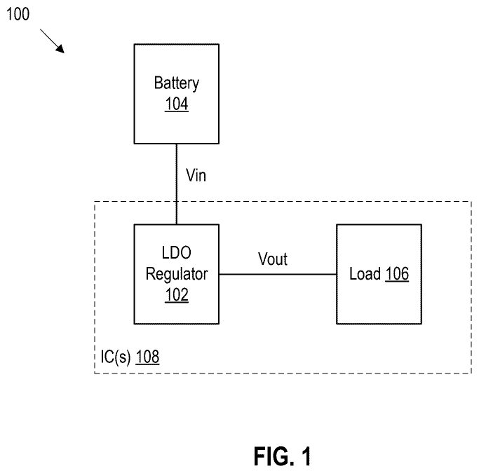

FIG. 1 is a block diagram depicting a device 100 according to some embodiments. Device 100 can include an LDO regulator 102, a battery 104, and a load circuit (“load 106”). A battery may be a source of electric power using electrochemical cell(s). A voltage regulator may be a circuit designed to output a stable voltage (referred to as a regulated voltage) from an input voltage. The input voltage can vary over time. A linear regulator may be a voltage regulator that can vary its resistance between input and output continuously to maintain a stable output voltage. An LDO regulator may be a type of linear voltage regulator that can generate regulated voltage even when the input-to-output voltage differential across its resistance (referred to as the dropout voltage) is small (e.g., on the order of tens to hundreds of millivolts). While different subcategories of voltage regulators are described by way of example (e.g., linear regulator or LDO regulator), it is to be understood that the voltage regulator described herein is not limited by any subcategory. Thus, LDO regulator 102 can be a voltage regulator as described by the various embodiments and claims herein and can have a subcategory of linear regulator or LDO regulator.

A load circuit may be a circuit that consumes power. In device 100, battery 104 can supply an input voltage (Vin) to LDO regulator 102. LDO regulator 102 can generate an output voltage (Vout) from the input voltage (Vin). LDO regulator 102 can supply the output voltage (Vout) to load 106. Load 106 can consume current supplied by LDO regulator 102. Load 106 can vary such that the current drawn from LDO regulator 102 varies. For example, load 106 can vary among no load, light load, moderate load, and heavy load conditions. The load conditions described herein by way of example are qualitative. No load can be a condition where load 106 draws no current. Light load can be a condition where load 106 draws a current at or near a minimum amount of current. Heavy load can be a condition where load 106 draws a current at or near a maximum amount of current. Moderate load can be a condition where load 106 draws an amount of current between light load and heavy load. LDO regulator 102 and load 106 can be part of one or more integrated circuits (ICs). An IC may be a circuit etched onto a semiconductor material. Device 100 can be any of a myriad of battery-powered devices known in the art.

One type of LDO regulator can include a reference voltage, an error amplifier, a pass element, such as a transistor, and a feedback network. The pass element can be coupled between the input and output of the LDO regulator. The pass element can control the current from the input to the output based on the error amplifier's output signal. The error amplifier can generate its output signal by comparing voltage from the feedback network, which can be derived from the output voltage, and the reference voltage. For low-current, low power LDO regulators (e.g., less than one microamp), the leakage current (e.g., junction and channel leakages) of the transistor pass element can have a large impact on output regulation at no load or light load conditions. To maintain operation, an LDO regulator can require a certain minimum current to be consumed by the load. This minimum current, however, may not be guaranteed (e.g., when LDO regulator 102 is designed separately from load 106).

For an LDO regulator that is not adaptive, the internal bias currents and control-loop gains can be fixed to ensure stable operation and performance for a range of loads. An LDO regulator can be adaptive where one or more parameters within the regulator's control loop can be adjusted dynamically depending on operating conditions. For example, an LDO regulator can sense the output current and adjust parameter(s) accordingly, such as bias currents and the gate drive of the pass transistor. For such an LDO regulator, the current sensing ratio can be large to ensure stability at light to moderate load conditions. However, such a large current sensing ratio can result in DC headroom issues and electromagnetic (EM) issues for heavy load conditions. Further, when an over-current or short-circuit event occurs, the excessive current drawn from the battery can degrade the current efficiency and battery life. An over-current event, which can be caused by a short-circuit or the like, can be a load condition where more current is drawn than the maximum current for which the LDO regulator is designed to output. An LDO regulator can be coupled to an external output capacitor. When the external output capacitor degrades under process/voltage/temperature (PVT) variations, the bandwidth of the LDO regulator can become too large to be able to maintain good stability margins and stable operation. Embodiments of LDO regulator 102 are described below that can exhibit sustainable current efficiency over a range of load conditions, e.g., from no load to heavy load conditions.

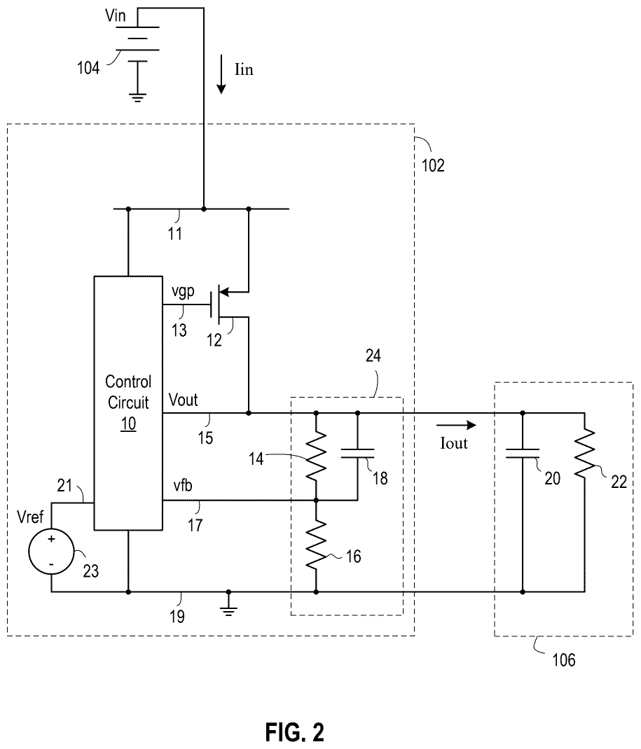

FIG. 2 is a schematic diagram depicting LDO regulator 102 coupled to load 106 according to some embodiments. LDO regulator 102 can include a control circuit 10, a transistor 12, and a network 24. LDO regulator 102 can include transistors, such as transistor 12. In embodiments, the transistors can be field effect transistors (FETs). A FET can be a four-terminal device having gate, source, drain, and substrate terminals. Unless otherwise indicated, the transistors described herein have their substrate terminals coupled to their source terminals and, as such, the substrate terminals are not explicitly shown. FETs can be p-channel FETs or n-channel FETs, where n and p refer to the type of doping in the semiconductor material and the type of majority charge carrier, as is known in the art. Consistent with convention, any n-channel transistors are shown schematically with the source as an arrow facing away from the gate and any p-channel transistors are shown schematically with the source as an arrow facing towards the gate. There are many types of FETs known in the art. One skilled in the art can select among one or more such FETs based on the description of the examples and embodiments herein. Metal-oxide semiconductor field-effect transistors (MOSFETs) are widely used and well-known FETs in ICs. P-channel MOSFETs can be referred to as PMOS transistors and N-channel MOSFETs can be referred to as NMOS transistors. Accordingly, for purposes of clarity, various examples and embodiments are described below within the context of NMOS transistors, PMOS transistors, or a combination thereof.

LDO regulator 102 can have various nodes. A node may be a point in a circuit where two or more circuit elements are connected. A node can be shown in the drawings as a filled circle at a wire junction. Note that, for ease of illustration, a node may be shown as two or more separate junctions connected by only wire(s) and no circuit elements (e.g., a short-circuit connection). In such case, a reference numeral assigned to the node can be at one of the junctions or at one of the wires between the junctions, all of which collectively represent the node. An electrical network (“network”) can be an interconnection of electrical components or a model of such interconnection. For example, network 24 can be an interconnection of a resistor 14, a resistor 16, and a capacitor 18. Capacitor 20 and resistor 22 can be a network that models load 106. Capacitors and resistors are components well-known in the art.

In embodiments, transistor 12 can be a PMOS transistor. The source of transistor 12 can be coupled to a node 11 and the drain of transistor 12 can be coupled to a node 15. Node 11 can receive the input voltage (Vin), e.g., from battery 104. Input voltage (Vin) can be a DC voltage. Node 15 can supply the output voltage (Vout) to load 106. Output voltage (Vout) can be a DC voltage. A DC voltage may be a voltage that drives current in one direction. The gate of transistor 12 can be coupled to a node 13, which supplies a gate voltage (vgp). Network 24 can be coupled between node 15 and a node 19. Node 19 can be at electrical ground. Electrical ground can be any voltage that provides a reference for other voltages (e.g., 0 volts). In an embodiment, network 24 can include resistors 14 and 16 and a capacitor 18. Resistor 14 can be coupled between node 15 and a node 17, which supplies a feedback voltage (vfb). Resistor 16 can be coupled between node 17 and node 19. Capacitor 18 can be coupled between node 15 and node 17 (e.g., in parallel with resistor 14). In this configuration, resistors 14 and 16 can form a voltage divider that supplies a fraction of the output voltage (Vout) as the feedback voltage (vfb). Feedback in a circuit may be when output is routed back as input. The voltage at node 17 can be a fraction of the output voltage, which is routed back to control circuit 10 and used as input to control transistor 12. Network 14 can have other configurations of components to provide the feedback voltage (vfb).

Load 106 can be modeled by a capacitor 20 and a resistor 22. The circuit modeled by capacitor 20 and resistor 22 can be any of a myriad of circuits used in devices, such as battery-powered devices. Capacitor 20 and resistor 22 can be in parallel and the parallel combination coupled between node 15 and node 19 (e.g., between Vout and electrical ground). Load 106 can consume current supplied by LDO regulator 102 (Iout). Quiescent current (Iq) for LDO regulator 102 can be the difference between input current (Iin) and output current (Iout). Power efficiency of LDO regulator 102 may be a fraction where the numerator is the product of the output current (Iout) and output voltage (Vout) and the denominator is the product of the input voltage (Vin) and the sum of the output current (Iout) and the quiescent current (Iq), e.g., (Iout*Vout)/[(Iout+Iq)*Vin]. For a given drop out voltage, minimizing quiescent current (Iq) can improve power efficiency.

A control circuit can be a circuit that exhibits control over component(s). Control circuit 10 can control transistor 12. Control circuit 10 can be coupled to nodes 11, 13, 15, 17, and 19. Control circuit 10 can control the gate voltage (vgp) supplied to transistor 12. Control circuit 10 can include multiple feedback loops, as discussed further below. A feedback loop may be a circuit that exhibits feedback. Control circuit 10 can use the output voltage (Vout), the feedback voltage (vfb), and a reference voltage (Vref) in the feedback loops to control the gate voltage (vgp). A voltage source 23 can supply the reference voltage (Vref) to a node 21. A voltage source may be a circuit that outputs a voltage independent of its load and supplied current within a range. Control circuit 10 can be coupled to node 21 to receive the reference voltage (Vref). Voltage source 23 can be coupled between nodes 21 and 19. Some embodiments of control circuit 10 are described below. Voltage source 23 can be, for example, a voltage reference, such as a bandgap voltage reference or the like known in the art.

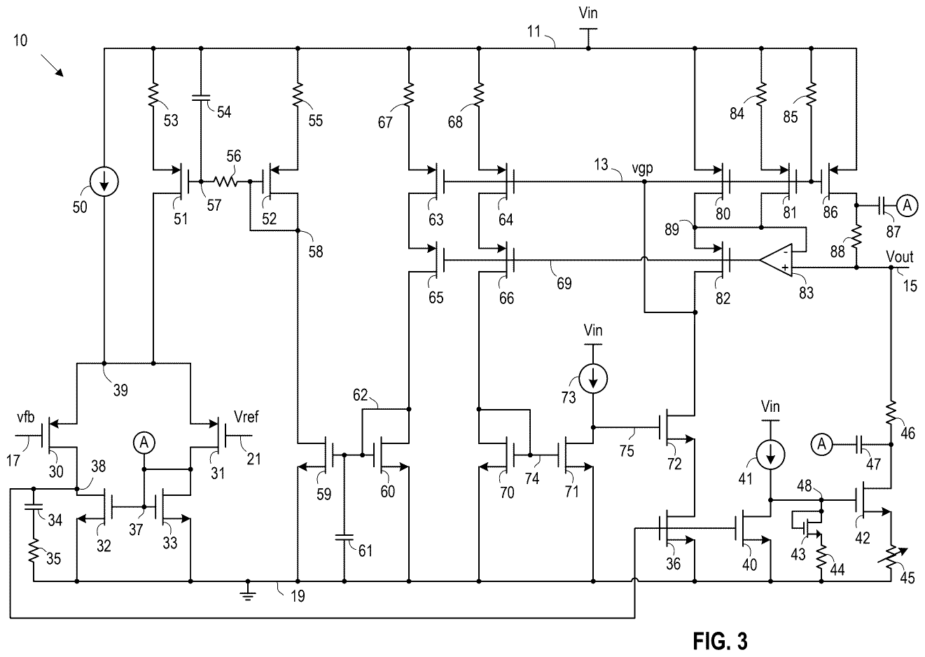

FIG. 3 is a schematic diagram depicting control circuit 10 according to some embodiments. Control circuit 10 can include transistors 30, 31, 32, and 33. Transistors 30 and 31 can be PMOS transistors. Transistors 32 and 33 can be NMOS transistors. The sources of transistors 30 and 31 can be coupled to a node 39. The drain of transistor 30 can be coupled to a node 38. The drain of transistor 31 can be coupled to a node 37. The gate of transistor 30 can be coupled to node 17 to receive the feedback voltage (vfb). The gate of transistor 31 can be coupled to node 21 to receive the reference voltage (Vref). The drain of transistor 32 can be coupled to node 38. The drain of transistor 33 can be coupled to node 37. The sources of transistors 32 and 33 can be coupled to node 19 (electrical ground). The gates of transistors 32 and 33 can be coupled to node 37. Accordingly, transistor 33 can be a diode-connected transistor. A diode-connected transistor may be a transistor having its drain coupled to its gate such that the transistor becomes a two-terminal device having the source terminal and the gate/drain terminal. Control circuit 10 can include a capacitor 34 and a resistor 35. A series combination of capacitor 34 and resistor 35 can be coupled between node 38 and node 19 (electrical ground).

Control circuit 10 can include a current source 50, transistors 51 and 52, resistor 53, capacitor 54, resistors 55 and 56, transistors 59 and 60, and capacitor 61. A current source may be a circuit that supplies current independent of the voltage across the current source within a range. Current source 50 can be coupled between node 11 and node 39. Transistors 51 and 52 can be PMOS transistors. The drain of transistor 51 can be coupled to node 39. The source of transistor 51 can be coupled to node 11 through resistor 53 (e.g., resistor 53 can be coupled between node 11 and the source of transistor 51). The gate of transistor 51 can be coupled to a node 57. Capacitor 54 can be coupled between node 11 and node 57. Resistor 56 can be coupled between node 57 and a node 58. Both the gate and the drain of transistor 52 can be coupled to node 58. Thus, transistor 52 can be a diode-connected transistor. The source of transistor 52 can be coupled to node 11 through resistor 55 (e.g., resistor 55 can be coupled between node 11 and the source of transistor 52). Transistors 59 and 60 can be NMOS transistors. The drain of transistor 59 can be coupled to node 58. The gate and the drain of transistor 60 can be coupled to a node 62. Thus, transistor 60 can be a diode-connected transistor. The sources of transistors 59 and 60 can be coupled to node 19 (electrical ground). Capacitor 61 can be coupled between node 62 and node 19 (electrical ground).

Control circuit 10 can include transistors 36, 70, 71, and 72, and a current source 73. Transistors 36, 70, 71, and 72 can be NMOS transistors. The gate and the drain of transistor 70 can be coupled to a node 74. Thus, transistor 70 can be a diode-connected transistor. The source of transistor 70 can be coupled to node 19 (electrical ground). The drain of transistor 71 can be coupled to a node 75. The gate of the transistor 71 can be coupled to node 74. The source of transistor 71 can be coupled to node 19 (electrical ground). Current source 73 can be coupled between node 11 and node 75. The drain of transistor 72 can be coupled to node 13. The gate of transistor 72 can be coupled to node 75. The source of transistor 72 can be coupled to the drain of transistor 36. The source of transistor 36 can be coupled to node 19 (electrical ground). The gate of transistor 36 can be coupled to node 38.

Control circuit 10 can include transistors 63, 64, 65, and 66, and resistors 67 and 68. Transistors 63, 64, 65, and 66 can be PMOS transistors. The source of transistor 63 can be coupled to node 11 through resistor 67 (e.g., resistor 67 can be coupled between node 11 and the source of transistor 63). The drain of transistor 63 can be coupled to the source of transistor 65. The drain of transistor 65 can be coupled to node 62. The source of transistor 64 can be coupled to node 11 through resistor 68 (e.g., resistor 68 can be coupled between node 11 and the source of transistor 64). The drain of transistor 64 can be coupled to the source of transistor 66. The drain of transistor 66 can be coupled to node 74. The gates of transistors 63 and 64 can be coupled to node 13. The gates of transistors 65 and 66 can be coupled to a node 69.

Control circuit 10 can include transistors 40, 42, and 43, a current source 41, resistors 44, 45, and 46, and capacitor 47. Current source 41 can be coupled between node 11 and a node 48. Transistors 40, 42, and 43 can be NMOS transistors. The drain of transistor 40 can be coupled to node 48. The source of transistor 40 can be coupled to node 19 (electrical ground). The gate of transistor 40 can be coupled to node 38. The gate and the drain of transistor 43 can be coupled to node 48. Thus, transistor 43 can be a diode-connected transistor. The source of transistor 43 can be coupled to node 19 (electrical ground) through resistor 44 (e.g., resistor 44 can be coupled between the source of transistor 43 and node 19). The drain of transistor 42 can be coupled to node 15 through resistor 46 (e.g., resistor 46 can be coupled between node 15 and the drain of transistor 42). Capacitor 47 can be coupled between the drain of transistor 42 and node 37. The source of transistor 42 can be coupled to node 19 (electrical ground) through resistor 45 (e.g., resistor 45 can be coupled between the source of transistor 42 and node 19). Resistor 45 can be a variable resistor or a device providing a variable resistance.

Control circuit 10 can include transistors 80, 81, 82, and 86, resistors 84, 85, and 88, capacitor 87, and error amplifier 83. An error amplifier may be a circuit that amplifies the difference between its two inputs. An error amplifier can supply a voltage as output based on comparison of the voltages on its inputs. Transistors 80, 81, 82, and 86 can be PMOS transistors. The source of transistor 80 can be coupled to node 11. The drain of transistor 80 can be coupled to a node 89. The source of transistor 81 can be coupled to node 11 through resistor 84 (e.g., resistor 84 can be coupled between node 11 and the source of transistor 81). The drain of transistor 81 can be coupled to node 89. The source of transistor 86 can be coupled to node 11. The drain of transistor 86 can be coupled to node 15 through resistor 88 (e.g., resistor 88 can be coupled between the drain of transistor 86 and node 15). The gates of transistors 80, 81, and 86 can be coupled to node 13. Capacitor 87 can be coupled between the drain of transistor 86 and node 37. Resistor 85 can be coupled between node 11 and node 13. The inverting input of error amplifier 83 can be coupled to node 89. The non-inverting input of error amplifier 83 can be coupled to node 15. The output of error amplifier 83 can be coupled to node 69. The source of transistor 82 can be coupled to node 89. The drain of transistor 82 can be coupled to node 13. The gate of transistor 82 can be coupled to node 69.

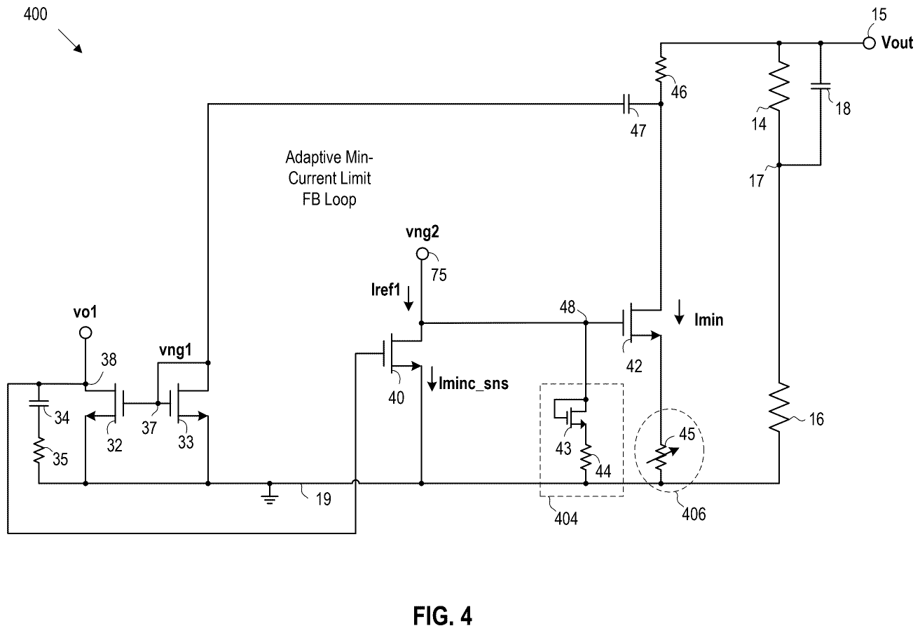

FIG. 4 is a schematic diagram depicting a feedback loop 400 of control circuit 10 according to some embodiments. Elements of FIG. 4 that are the same or similar to those of FIG. 3 are designated with identical reference numerals. Elements not relevant to feedback loop 400 are omitted from FIG. 4 and shown in FIG. 3 described above. In some embodiments, feedback loop 400 can apply an adaptive minimum current limit. Feedback loop 400 can address the leakage-induced load regulation problem while offering sustainable high-current efficiency from no load condition to light load condition. Feedback loop 400 can provide a minimum load current automatically and thus maintain proper output regulation. Feedback loop 400 can remain off at typical load conditions and can be enabled automatically when minimum load current is needed. Feedback loop 400 can remain off automatically whenever enough system load is engaged, which can provide for current efficiency and sustainable output regulation.

Transistor 40 can operate as a current-sensing device to sense current in the second stage of the main feedback loop (discussed below). The second stage current flows through transistor 36 (FIG. 3), which in turn tracks the current through transistor 12. Transistor 40 can share the same gate with transistor 36 and can form a current mirror. A current mirror may be a circuit that supplies one current based on another current (e.g., a type of current source). The two currents can be the same (e.g., mirrored) or proportional to each other. Current source 73 can supply a current (Iref1), which can be a reference bias current used to define a threshold to enable the minimum current limit. Transistor 42 can operate as the output driving stage with sinking capability. At nominal conditions, the current through transistor 40 (Iminc_sns) can be greater than the reference current (Iref1). In this case, reference current (Iref1) can provide a threshold against which the current Iminc_sns can be compared in feedback loop 400. In such case, the voltage at node 75 (vng2) can be pulled down to turn off transistor 42. When transistor 42 is off, feedback loop 400 can be off and the current (Imin) through transistor 42 can be at or near zero. A current path may be a path for current in a circuit. When the voltage at node 75 is less than the threshold voltage of transistor 42, a current path through resistor 46 and transistor 42 between nodes 15 and 19 can be disconnected. In case a large leakage exists or the existing current drawn by the load is not adequate, the current through transistor 36 and the current through transistor 40 (Iminc_sns) can be reduced and the gate voltage of transistor 36 can become too low to maintain proper loop gain and output regulation. Once the sensed current (Iminc_sns) is less than the reference current (Iref1), the voltage at node 75 (vng2) can be pulled high to turn on transistor 42, which conducts a current (Imin) to sink the required minimum current and ensure proper output regulation. Thus, in this scenario, feedback loop 400 can provide a current path through resistor 46 and transistor 42 between nodes 14 and 19 to conduct the current Imin. Resistor 45 can operate as a current-limiting resistor and can set an upper boundary of the minimum current limit. In some embodiments, resistor 45 can be replaced with an NMOS transistor having its drain coupled to the source of transistor 42 and its source coupled to node 19 (electrical ground). Such an NMOS transistor can be a current source used to set the upper boundary of the minimum current limit. Transistor 43 and resistor 44 can function as a local impedance attenuator to limit the loop gate and ensure loop stability. Resistor 46 and capacitor 47 can form an adaptive damping factor control-based frequency compensation network for feedback loop 400. This network is discussed further below.

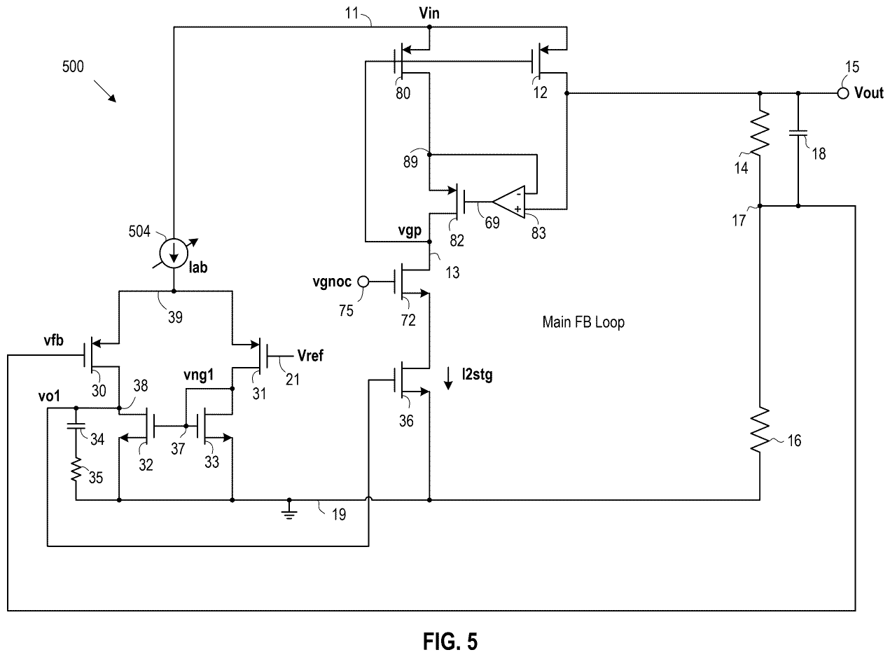

FIG. 5 is a schematic diagram depicting another feedback loop 500 of control circuit 10 according to some embodiments. Elements of FIG. 5 that are the same or similar to those of FIG. 3 are designated with identical reference numerals. Elements not relevant to feedback loop 500 are omitted from FIG. 5 and shown in FIG. 3 described above. Feedback loop 500 can be a main feedback loop with adaptive bias for adjusting the gate voltage (vgp) at node 13. Feedback loop 500 can ensure power efficiency at light load conditions while achieve high bandwidth at heavy load conditions.

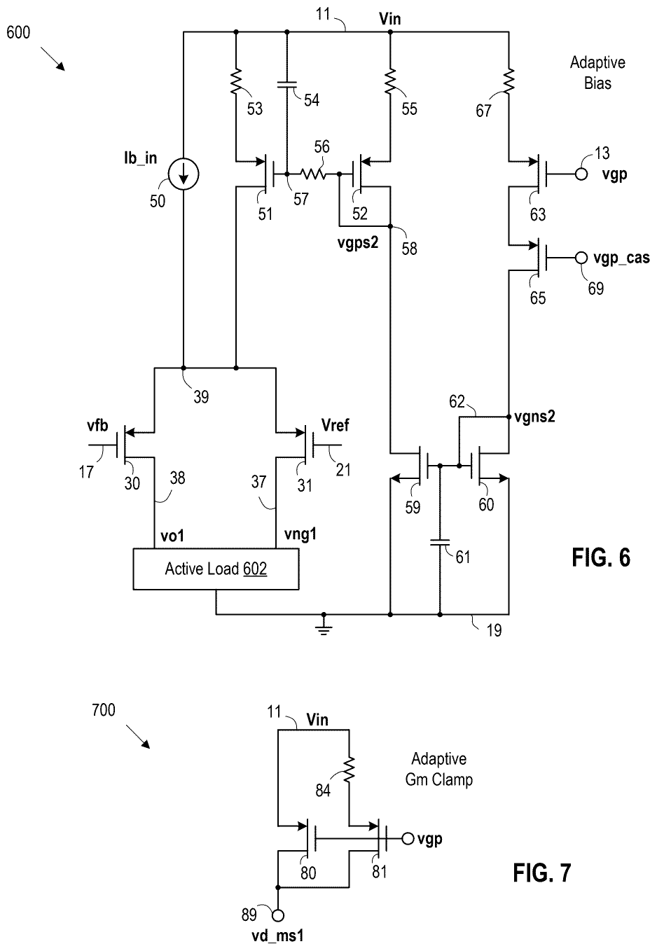

Feedback loop 500 can be formed by a first gain stage (transistors 30, 31, 32, and 33), a second gain stage (transistors 36 and 80), the output power transistor (transistor 12), and network 24 (e.g., resistors 14, 16 and capacitor 18). A current source 504 coupled between nodes 11 and 39 can model the adaptive bias current (Iab), discussed further below with respect to FIG. 6. Transistor 80 can operate as a current sensing device to boost gain and slew rate at the output of the second stage (e.g., transistor 36). Error amplifier 83 and transistor 82 can form a local negative feedback loop to ensure the drain voltage of transistor 80 matches the drain voltage of transistor 12 (output stage). This can be to ensure proper current sensing by transistor 80.

Transistors 30 and 31 can be a differential transistor pair. A differential transistor pair may be a circuit that amplifies a difference between two input voltages. The first and second gain stages described above can form an error amplifier. The inputs of the error amplifier can be the feedback voltage (vfb) and the reference voltage (Vref). The output of the error amplifier can be the second stage current (I2stg) through transistor 36, which is converted to the voltage (vgp) to control transistor 12.

FIG. 6 is a schematic diagram depicting an adaptive bias loop 600 for an LDO regulator according to some embodiments. Elements of FIG. 6 that are the same or similar to those of FIG. 3 are designated with identical reference numerals. Elements not relevant to the adaptive bias loop 600 are omitted from FIG. 6 and shown in FIG. 3 described above. Adaptive bias loop 600 can include two PMOS current mirrors (transistor 63, transistor 52, and transistor 51) and one NMOS current mirror (transistor 59 and transistor 60). Transistor 65 can operate as a cascode for transistor 63, which can be a current sensor. Error amplifier 83 and transistor 65 can for a local negative feedback loop to ensure the drain voltage of transistor 63 matches the drain voltage of transistor 12 (output stage). This can be to ensure proper current sensing by transistor 63. The adaptive bias loop 600 can boost the bandwidth at heavy load condition.

FIG. 7 is a schematic diagram depicting a transconductance clamp 700 according to some embodiments. Elements of FIG. 7 that are the same or similar to those of FIG. 3 are designated with identical reference numerals. Elements not relevant to transconductance clamp 700 are omitted from FIG. 7 and shown in FIG. 3 described above. Transconductance clamp 700 can provide a large gain at light to moderate load conditions, can address headroom issues, and can improve current efficiency at moderate to heavy load conditions. Transconductance may be the ratio of the change in current at an output terminal of a device to the change in voltage at an input terminal of the device. Transconductance clamp 700 can include transistor 80, transistor 81, and resistor 84. The effective transconductance can be gms1+gms2/(1+gms2*Rs2), where gms1 is the transconductance of transistor 80, gms2 is the transconductance of transistor 81, and Rs2 is the resistance of resistor 84. At light to moderate load conditions, the transconductance of clamp 700 can be as large as (gms1+gms2), as the impact of resistor 84 can be negligible. At moderate to heavy load conditions, the equivalent transconductance can be reduced to gms1+1/Rs2, given gms2*Rs2>1. In this manner, a larger second stage current (I2stg) conducted by transistor 36 and a larger loop gain can be achieved at light to moderate load conditions for proper voltage regulation. Further, the second stage current (I2stg) can be reduced for improved current efficiency at moderate to heavy load conditions.

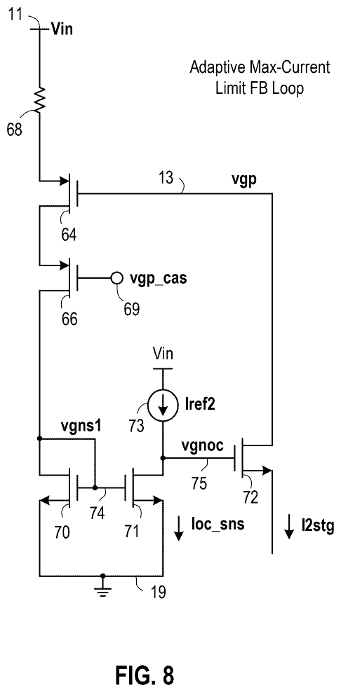

FIG. 8 is a schematic diagram depicting another feedback loop 800 of control circuit 10 according to some embodiments. Elements of FIG. 8 that are the same or similar to those of FIG. 3 are designated with identical reference numerals. Elements not relevant to feedback loop 800 are omitted from FIG. 8 and shown in FIG. 3 described above. Feedback loop 800 can provide an adaptive maximum current limit to limit the current drawn from the DC voltage source (e.g., the battery) in case of over-load or short-circuit conditions. This can prolong battery life in case of such abnormal conditions. Feedback loop 800 can be formed from transistor 64, resistor 68, transistor 70, transistor 71, current source 73, and transistor 72. Feedback loop 800 can be off at normal load conditions. Feedback loop 800 can be nearly off at no load condition, which can help minimize quiescent current (Iq). Feedback loop 800 can be enabled automatically in response to an over-load or short-circuit condition. Transistor 84 can be a current sensing device to sense the load current. Transistor 84 can share the same gate with transistor 12 (the output stage). Transistor 84 can form a current mirror with transistor 12. Resistor 68 can be a current limiter. Transistors 70 and 71 can form an NMOS current mirror. Current source 73 can supply a reference bias current that can define the threshold to enable feedback loop 800. Transistor 72 can be the output driving stage of feedback loop 800. At normal load conditions, the current through transistor 71 (Ioc_sns) can be less than the reference current (Iref2) from current source 73. The gate voltage of transistor 72 can be pulled up to the input voltage (Vin) to turn on transistor 72 so that feedback loop 800 is open (off). Transistor 72 can behave as an active resistor having a small resistance that does not impact the gate voltage (vgp) on node 13. Given an over-load/short-circuit condition, the current in transistor 71 (Ioc_sns) can be increased. Once the sensed current (Ioc_sns) is greater than the reference current (Iref2) from current source 73, the gate voltage vgnoc of transistor 72 can be pulled down to limit the driving capability of transistor 72, providing a maximum load current. That is, feedback loop 800 can generate a current (Ioc_sns) that is proportional to the current through transistor 12. Feedback loop 800 can control the gate voltage vgnoc to limit the current through transistor 12 in response to the current Ioc_sns exceeding a threshold. Feedback loop 800 can achieve better accuracy than that of open-loop control. The maximum current can be set to Iref2*k, where k represents the current mirror ratio.

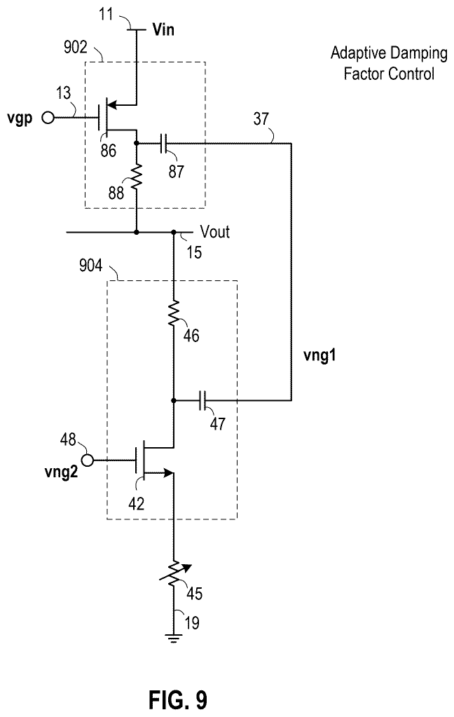

FIG. 9 is a schematic diagram depicting adaptive damping factor control (ADFC)-based frequency compensation in control circuit 10 according to some embodiments. Elements of FIG. 9 that are the same or similar to those of FIG. 3 are designated with identical reference numerals. Elements not relevant to ADFC-based frequency compensation are omitted from FIG. 9 and shown in FIG. 3 described above. The ADFC-based frequency compensation can be employed for boosting stability margin at moderate to heavy load conditions to support a wide range of load capacitance. The ADFC-based frequency compensation does not consume additional power since the sensed current can be recycled to the output load and thus current efficiency can be maintained. Transistor 86, resistor 88, and capacitor 87 can form a frequency compensation network 902 to boost stability margin. The current through transistor 86 can be proportional to the current through transistor 12. Transistor 86 can supply current to the network comprising resistor 88 and capacitor 87. Frequency compensation network 902 can provide a feed-forward zero that is controlled by gm_c*Rc*Cc, where gm_c is the transconductance of transistor 86, Rc is the resistance of resistor 88, and Cc is the capacitance of capacitor 87. At no load to light load conditions, where the transconductance of transistor 86 can be small, the network can be considered as a parasitic capacitance. For moderate to heavy load conditions, network 902 can start to provide an additional zero controlled by gm_c*Rc*Cc to boost stability margin. Transistor 42, resistor 46, and capacitor 47 can form a frequency compensation network 904 that functions similar to network 902.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

As used herein, the term “couple” or “connect” and its derivatives include: (a) electrical and communicative coupling or connecting; and (b) do not imply a direct coupling or connection, but rather may include intervening elements, unless described as “directly coupled” or “directly connected.”

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A voltage regulator, comprising:
a first node configured to receive a first direct-current (DC) voltage;
a second node configured to supply a second DC voltage;
a third node configured to supply an electrical ground;
a first transistor coupled between the first node and the second node;
a first network coupled between the second node and the third node, the first network outputting a first voltage; and
a control circuit including: an error amplifier configured to supply a third voltage to a gate of the first transistor based on comparison of the first voltage with a second voltage; and a first circuit coupled between the second node and the third node, the first circuit configured to provide a current path between the second node and the third node in response to a first current through the first transistor being less than a threshold and disconnect the current path otherwise.

2. The voltage regulator of claim 1, wherein the first circuit comprises:
a second transistor coupled between the second node and the third node;
a third transistor coupled between a gate of the second transistor and the third node; and
a current source configured to supply a second current to the third transistor.

3. The voltage regulator of claim 2, wherein the error amplifier includes a differential transistor pair having an input configured to receive the first voltage and the second voltage and an output having a fourth node configured to supply a fourth voltage and a fifth node configured to a fifth voltage, and wherein a gate of the third transistor is coupled to the fourth node.

4. The voltage regulator of claim 3, wherein the first circuit comprises:
a resistor coupled between the second node and the second transistor; and
a capacitor coupled between the second transistor and the fifth node.

5. The voltage regulator of claim 3, wherein the error amplifier comprises a fourth transistor coupled between the gate of the first transistor and the third node, a gate of the fourth transistor coupled to the fourth node.

6. The voltage regulator of claim 2, wherein the first circuit comprises:
a resistor or fourth transistor coupled between the second transistor and the third node.

7. The voltage regulator of claim 2, wherein the first circuit comprises:
a diode-connected transistor and a resistor coupled in series between second transistor and the third node.

8. A voltage regulator, comprising:
a first node configured to receive a first direct-current (DC) voltage;
a second node configured to supply a second DC voltage;
a third node configured to supply an electrical ground;
a first transistor coupled between the first node and the second node;
a first network coupled between the second node and the third node, the first network outputting a first voltage; and
a control circuit including: a first error amplifier configured to supply a third voltage to a gate of the first transistor based on comparison of the first voltage with a second voltage; and a first circuit configured to: generate a second current proportional to a first current through the first transistor; and control the third voltage to limit the first current in response to the second current exceeding a threshold.

9. The voltage regulator of claim 8, wherein the first circuit comprises:
a second transistor coupled to the first node, a gate of the second transistor coupled to the gate of the first transistor;
a diode-connected transistor coupled between the second transistor and the third node;
a current source;
a third transistor coupled between the current source and the third node; and
a fourth transistor coupled between an output of the first error amplifier and the gate of the first transistor, a gate of the fourth transistor coupled to the third transistor and the current source.

10. The voltage regulator of claim 9, wherein the first circuit further comprises:
a fifth transistor coupled between the second transistor and the diode-connected transistor;
a second error amplifier having an output coupled to a gate of the fifth transistor, a first input coupled to the second node, and a third input coupled to a fourth node to receive a fourth voltage.

11. The voltage regulator of claim 10, wherein the control circuit comprises:
a sixth transistor coupled between the first node and the fourth node, a gate of the sixth transistor coupled to the gate of the first transistor.

12. The voltage regulator of claim 11, wherein the control circuit comprises:
a seventh transistor coupled between the first node and the fourth node, a gate of the seventh transistor coupled to the gate of the first transistor; and
a resistor coupled between the seventh transistor and the first node.

13. The voltage regulator of claim 10, wherein the first circuit further comprises:
a resistor coupled between the second transistor and the first node.

14. The voltage regulator of claim 10, further comprising:
a resistor coupled between the first node and the gate of the first transistor.

15. A voltage regulator, comprising:
a first node configured to receive a first direct-current (DC) voltage;
a second node configured to supply a second DC voltage;
a third node configured to supply an electrical ground;
a first transistor coupled between the first node and the second node;
a first network coupled between the second node and the third node, the first network outputting a first voltage; and
a control circuit including: a first error amplifier configured to supply a third voltage to a gate of the first transistor based on comparison of the first voltage with a second voltage; and a first circuit configured to: generate a second current proportional to a first current through the first transistor; and supply the second current to a second network coupled to the second node and the first error amplifier.

16. The voltage regulator of claim 15, wherein the first circuit comprises a second transistor coupled to the first node, a gate of the second transistor coupled to the gate of the first transistor, and wherein the second network comprises a resistor coupled between the second transistor and the second node, and a capacitor coupled between the second transistor and the first error amplifier.

17. The voltage regulator of claim 15, further comprising:
a second circuit configured to supply a third current to the first error amplifier, the second circuit including: a first current mirror configured to supply a fifth current in response to a fourth current; a second current mirror configured to supply a sixth current in response to the fifth current; and a current source configured to supply a seventh current, the third current being a sum of the sixth and seventh currents.

18. The voltage regulator of claim 17, wherein the second circuit further comprises:
a second transistor coupled between the first node and the first current mirror, the second transistor configured to supply the fourth current.

19. The voltage regulator of claim 18, wherein the second circuit further comprises a resistor coupled between the second transistor and the first node.

20. The voltage regulator of claim 19, wherein the control circuit further comprises:
a third transistor coupled between the second transistor and the first current mirror; and
a second error amplifier having an output coupled to a gate of the third transistor, a first input coupled to the second node, and a third input coupled to a fourth node to receive a fourth voltage.
